(19) United States
(12) Patent Application Publication
(10) Pub. No.: US 2024/0008478 A1
(43) Pub. Date: Jan. 11, 2024

(54) Composition and Methods for Managing and Controlling Lepidopteran Insects

(71) Applicant: ISCA Technologies, Inc., Riverside, CA (US)

(72) Inventors: Agenor Mafra-Neto, Riverside, CA (US); Rafael Borges, Fraiburgo (BR)

(21) Appl. No.: 18/347,726

(22) Filed: Jul. 6, 2023

Related U.S. Application Data
(60) Provisional application No. 63/367,945, filed on Jul. 8, 2022.

(51) Int. Cl. A01N 25/00; A01N 47/10; A01N 43/16

(52) U.S. Cl. CPC A01N 25/006; A01N 47/10; A01N 43/16

(57) ABSTRACT

Compositions and methods of using the compositions for controlling a noctuid population, wherein the compositions contain at least one noctuid attractant. The compositions may further include a feeding stimulant and/or a pesticide.

### CROSS-REFERENCE TO RELATED APPLICATIONS

This application claims the benefit of U.S. Provisional Patent Application No. 63/367,945, filed on Jul. 8, 2022, the teachings of which are expressly incorporated by reference.

### STATEMENT RE: FEDERALLY SPONSORED RESEARCH/DEVELOPMENT

NOT APPLICABLE

### BACKGROUND

The present disclosure relates generally to compositions and methods for protecting row crops from noctuid pests, and more particularly to attract-and-kill (A&K) formulations. In general, noctuid moths include some of the most damaging pests in the world, including corn earworm (Helicoverpa zea), cotton bollworm (H. armigera), and fall armyworm (Spodoptera frugiperda). Noctuid pests feed on an extensive range of row and vegetable crops, including many of the world's most critical food staples, such as corn, wheat, and soybean. H. zea and H. virescens together inflict >$1 billion in damage to US crops. H. armigera, not yet established in the US, causes an estimated $5 billion in global losses. Its recent invasion of South and Central America beginning in 2012/2013 and the frequency of its detection at US points of entry demonstrates the enormous risk it poses to the agricultural industries. Noctuids share a number of characteristics that make them difficult to control by conventional means, including high reproductive and dispersal capacity, broad host plant ranges, internal feeding habits among larvae—shielding them from contact with pesticide sprays—and their capacity to develop resistance to multiple insecticides. Several noctuids have even begun to show signs of resistance to genetically modified (GM) crops designed to express the insecticidal proteins found in the bacteria Bacillus thuringiensis.

One of the most destructive groups of insect pests in the world are moths belonging to the family Noctuidae. Noctuids are distributed worldwide, with 2,900 species in North America. While it would be impossible to provide a full accounting of impacts of all noctuid pests of concern—some estimates indicate that nearly all cultivated plants are attacked by at least one noctuid—some of the most impactful species are listed below.

Corn earworm, Hehcoverpa zea. Considered the most destructive pest of crops in North America, corn earworm is found throughout the continent with the exception of Alaska and northern Canada. This pest is active year-round in tropical and subtropical zones but is incapable of overwintering further north; the northern limit of its year-round range is typically recognized as about 40° north latitude. However, this species is capable of migrating northwards from this range during warmer months, increasing the area over which crop damage may be inflicted. In addition to this extensive geographic range, corn earworm preys on an equally broad range of host crops. H. zea attacks ˜120 plants in 29 families (>30 crops in the US), including row crops, such as sorghum, corn, cotton, rice, soybean, and wheat; vegetables, such as tomato, asparagus, cabbage, green beans, cucumber, spinach, potato, lettuce; as well as fruits such as cantaloupe, melon, grape, peach, and avocado. Larvae are responsible for all crop damage; adult moths feed only on floral nectars. H. zea is the most damaging pest on sweet corn, where young larvae typically begin feeding on corn silks and developing flowers, moving to the interior of the ear as they grow, often feeding near the tip but sometimes consuming half the kernels before completing the larval stage. In some cases, as in sweet corn, damage renders the crop unsalable, while creating a loss in yield in seed corn, exacerbated by collateral losses in undamaged corn weeded out through sorting processes. In total, annual damage caused by H. zea and Heliothis virescens across their combined host range in the US amounts to >$1 billion, in spite of the $250 million spent annually on pesticide applications targeting them. In 2019, unusually large H. zea populations were reported across North America's Corn Belt (Iowa, Maryland, Michigan, Ohio, and Ontario), and moths appeared in northern regions ˜1 month earlier than is typical for the species, leading to concerns that field corn crops as well as sweet corn might be threatened.

Cotton bollworm, Helicoverpa armigera, also is considered one of the most serious agricultural pests on the globe and the most impactful pest in Africa, Europe, Asia, and Australasia, causing an estimated $5 billion/year in losses worldwide. Until 2013, when this species was recorded in Brazil, H. armigera was thought to be absent from North and South America, but in the months following this initial detection, the pest continued to spread, causing billions of dollars in losses in soybean and cotton in the 2012/2013 season. A year after its detection in Brazil, H. armigera was also found in Puerto Rico and Argentina. H. armigera has the potential to colonize nearly half (49%) of the North American land mass, meaning that its potential impacts could eclipse those of H. zea on cotton and corn. This is an alarming prospect, considering the frequency of this species' detection at US ports of entry: Individuals of H. armigera or “Helicoverpa spp.” have been intercepted 4,431 times since 1985. Like H. zea, H. armigera has a broad host range, constituting a major threat to cotton, sorghum, tomato, chickpea, maize, potatoes, okra, soybeans, and a range of fruit and vegetable crops.

Fall armyworm, Spodoptera frugiperda, is native to subtropical America, but because of its strong flying capacity, it is able to migrate north each summer as far as Canada. In the southern US, multiple generations of the pest occur each year. S. frugiperda feeds on >350 plants, including cotton, sorghum, rice, maize, sugarcane, and multiple vegetable crops. Late-stage larvae can completely defoliate a host, leaving only the ribs and stalks of corn plants intact. It was reported in 1992 that fall armyworm larval densities of 0.2-0.8 larvae per plant in the late whorl stage could reduce yields by 5-20%. Fall armyworm is recognized as the most important maize pest in Brazil, the third largest global maize producer; >$600 million is spent on fall armyworm control measures in Brazil each year. S. frugiperda also feeds on cotton, in which larvae hollow out the cotton boll, and on vegetables such as tomatoes and peppers, where larvae destroy growing points and can cause fruit rot or drop-off. When FAW attacks cereal crops, it can cause losses up to 100%. This species has been repeatedly detected at quarantine interception points in Europe, and in 2016 was reported in Africa, where it has since spread to 44 countries and become a significant threat to maize, a staple food for >300 million African farmers. Current estimates state that of the 2.9 million ha devoted to maize production, one quarter is infested with S. frugiperda, with >134,000 tons of maize lost—a quantity that could have fed >1 million people. In 2018-2019, it spread through Asia, including 24 provinces in China. The pest is now moving northward in China at an increasing rate and affected >1 million ha of farms in 2019. In response to these threats, the UN FAO launched a half billion-dollar initiative, Global Action for FAW Control, to develop and implement more effective prevention and mitigation strategies to deal with this pest.

Tobacco budworm, Heliothis (Chloridea) virescens is found year-round in the southern US, with 4-5 generations a year. This pest is particularly harmful to tobacco and has been for 200 years, at one point causing damage amounting to the current equivalent of $1,920/ha. In the 1930s, H. virescens was reported as a serious pest of cotton, a crop cultivated over an area 20× larger than is used for tobacco. Young cotton bolls may be hollowed out by budworm larvae and contaminated with their frass. Soybean pods and seeds also can be consumed by tobacco budworm. H. virescens is capable of feeding on >100 plant species, including soybean, cabbage, lettuce, pea, squash, and tomato.

As is apparent from these descriptions, noctuids share many characteristics that make them particularly destructive pests, such as 1) high reproductive capacity, 2) high dispersal capacity, 3) voracious feeding habits, 4) broad host range, often overlapping between different noctuid groups, exacerbated by 5) difficulties distinguishing between species. Many noctuids are capable of multiple generations per year and females often lay hundreds or thousands of eggs during their lifetime. H. virescens females lay 500-1,000 eggs over 2-3 weeks, while H. zea can lay up to 3,000 eggs over a 2-week lifespan. Noctuid larvae are typically voracious feeders, capable of stripping entire crop fields in a matter of days. Fall armyworm can destroy up to 80% of grain legume crops, important food staples throughout the world, during severe outbreaks. Noctuid moths are generally strong fliers and utilize air currents to aid their travel. S. frugiperda have been found using low-level jet streams, enabling them to fly from Mississippi to Canada in 30 hours. Adult H. armigera are capable of migrating distances of up to 2,000 km. This migratory capacity, coupled with high reproductive rates, makes noctuids well equipped to establish new populations when introduced to new environments. Their economic impacts are exacerbated by the large number of crops susceptible to these pests—H. zea, H. virescens, and H. armigera have reported host ranges of >100 plant species, and S. frugiperda attacks >350 species—and by the fact that host plants overlap across different genera, making several crops susceptible to two or more noctuid pests. Determining which species are actually present in the field can be quite challenging, as many adult noctuid moths share similar or near-identical morphologies. H. armigera and H. zea, for example, are so physically similar that to distinguish one from the other requires either molecular analysis or minute dissection of the male genitalia.

In order to overcome these problems, a broad array of control methods has been developed to manage noctuids in susceptible crops. Cultural control methods for noctuids include trap cropping (planting preferred plants near the crop to attract pests away from it), elimination of weeds and other wild hosts, timing of crop planting or harvesting to avoid the feeding stages of the pests, and tillage of soil to reduce successful overwintering of species that pupate underground. Efficacy of these techniques varies by species. Trap cropping may initially provide good results, but maintaining attractiveness of the trapping material over extended periods can be challenging. While tillage is often recommended for noctuid control, reduced tillage, resulting in extensive crop residue in the field, has actually been found to delay invasion of the crop by fall armyworm, reducing the need for pesticide application. Biological control is often cited as another option for noctuid management, suppressing pest populations through the use of pathogenic viruses, bacteria, or natural enemies, but effectiveness of these techniques in suppressing pest populations varies by species and crop. For alfalfa looper, biological control is often enough to suppress larval populations below economic thresholds, but in several other noctuids, such as heliothines, soybean looper, cabbage looper, and alfalfa looper, natural enemies are typically not an effective strategy for preventing crop damage, especially when populations are high.

Chemical control of noctuids has a long and varied history in the US, employing broad range of pesticides: the arsenic-based Paris Green, carbaryl, chlorpyrifos, malathion, esfenvalerate, lambda-cyhalothrin, pyrethroids sulprofos, profenofos, and thiodicarb. More recently, botanical insecticides derived from neem have demonstrated potential for noctuid control, but their use is hampered under field conditions by their susceptibility to environmental degradation. In addition, conventional pesticides target immature stages of noctuids, need to cover the entire plant to be effective, and are often ecologically disruptive. Most chemical control options also have negative impacts on natural enemies, which may exacerbate crop damage by the target pest.

Unfortunately, many of the same characteristics that make noctuids such harmful pests also impede efforts to control them. The fact that many noctuids feed on the same crops and are difficult to distinguish from each other complicates control actions, especially in cases where species-specific controls are used. Noctuid feeding behavior is also problematic. Insecticide sprays are more effective against young larvae, so proper timing of applications is paramount, but because they often feed within plant structures, detection may be difficult. Internal feeding also provides a physical shield against pesticide sprays, sometimes requiring large volumes of chemicals to be applied. Perhaps the most important attribute of noctuid biology and behavior is these insects' capacity to rapidly evolve pesticide resistance, defined as the loss of susceptibility to a toxin through repeated or continual exposure. Several noctuids have developed widespread resistance, including Spodoptera, Heliothis, and Helicoverpa spp. H. armigera has developed resistance to three broad-spectrum pesticide groups, carbamates, pyrethroids, and organophosphates; while H. virescens has shown resistance to pyrethroids, organophosphates, and Bacillus thuringiensis. Fall armyworm is resistant to six different chemical groups with six independent modes of action (29 distinct AIs, including chlorpyrifos, chlorantraniliprole, methomyl, permethrin, and thiodicarb).

Noctuids' capacity to develop resistance now threatens one of the most innovative and beneficial developments in modern row crop agriculture: genetic modification of crops to incorporate insecticidal toxins found in Bacillus thuringiensis (Bt). This technology essentially enabled crops to become their own defense mechanism against herbivorous insects, incorporating genes encoding Bt delta-endotoxins into their own genetic material. This gene splicing causes these tissues to express Bt proteins, which are toxic to many pest larvae, but are harmless to people and livestock as well as pollinators, such as honeybees. The first GM Bt crops were introduced in 1996 and quickly revolutionized the cultivation of row crops all over the world. Transgenic crops have proven effective against a broad range of pest species, including several noctuids, and provide the additional benefit of reducing traditional pesticide use. In Texas and the Midsouth and Southeast regions of the US, cotton crop damage was reduced following the introduction of Bt crops (1986-1995) by 63, 47, and 60% respectively. Rates of insecticide use also decreased in these regions by 81, 61, and 79%, respectively. Because of these advantages, Bt cotton and corn crops gained rapid adoption among agricultural producers in this area: ˜2.2 million of the 3.1 million ha of cotton grown here were planted with Bt strains in 2015. Bt crops accounted for 81% of the total US area devoted to corn in the same year.

Despite precautions taken to prevent the development of resistance to Bt crops—requirements that Bt cultivars express toxins in high enough concentrations to kill virtually all pests exposed to them; the setting aside of “refuge” areas, where Bt varieties are absent, allowing for the production of pests experiencing no selective pressure to develop resistance—recent field results suggest that the GM crop approach is becoming less effective. Resistance to Bt toxins and crops has already been reported for multiple Lepidopteran and Coleopteran spp. In 2005, resistance to Bt crops was documented in only three cases; in 2020, there have been 22 cases of practical resistance reported affecting nine key pest species, including H. zea resistance to Bt corn, fall armyworm to the Cry1F, Cry1Ac, Cry1ab, and Cry1A.105 Bt toxins, and H. armigera to Bt cotton in China and to the Cry1Ac toxin in Pakistan. The first documented case of field resistance to the Vip3Aa insecticidal protein in H. zea was reported in the US in 2020. Furthermore, one advantage of Bt as a management strategy—its inclusion of many different insecticidal molecules thought to serve as a bulwark against the development of resistance—has recently been called into question. It has long been believed that resistance developed on a toxin-by-toxin basis, suggesting that if one Bt compound lost its efficacy, it could simply be replaced by another. However, recent studies have shown that resistance to Bt in H. virescens is not limited to a single toxin class but may allow for cross resistance with other Bt toxins with different structures and activities. These findings suggest that one approach that has been proposed to stave off the development of GM crop resistance, the “stacking” of multiple Bt proteins into new strains, may ultimately prove nonviable. GM seed producers such as Monsanto and DOW+Dupont+Pioneer, project that the commercial life of a new GM product must be at least a decade from launch before the pests become resistant to justify the high cost of development (˜$136 million for a single GM trait). Lately, GM products have been falling far short of this requirement, lasting less than 5 years. A recent GM corn product launched in Brazil by Dupont was lost to resistance by fall armyworm in just 18 months.

As the shortcomings associated with conventional pesticides have become clearer (health risks to workers, consumers, and nontarget species, particularly beneficial insects such as pollinators; and susceptibility to resistance), certain sectors of agriculture have turned to an alternative means of pest control: the use of insect semiochemicals (behavior-modifying chemicals) to protect crops by a variety of means, such as reducing their rate of reproduction (as through mating disruption), driving them away from susceptible plants (repellency), or drawing them to a trap or a source of insecticide to remove them from the field (mass trapping or attract-and-kill). Semiochemical-based pest control holds many advantages over traditional insecticides. Most semiochemicals are short-lived and nature-identical, without adverse effects on human health. They also tend to be more specific in their activity, not affecting non-target species such as pollinators and natural enemies, and are less susceptible to development of resistance, a continual problem for control of noctuid pests. Furthermore, semiochemical strategies can be employed to suppress pest populations in the field with drastically reduced inputs of harmful chemical pesticides, as is the case with attract-and-kill or with no pesticide use at all, as with mating disruption and mass trapping. Large-scale implementation of semiochemical control techniques to protect both agricultural crops and forestry resources have yielded significant reductions in pesticide use while maintaining acceptably low crop-damage levels. Two of the most well-known area-wide insect management programs using semiochemicals are the codling moth mating disruption program across the northwestern US, which now covers 90% of the acreage cultivated for apples in Washington, Oregon, and California and succeeding in reducing insecticide use to just a few sprays per season; and the US Forest Service Slow the Spread of the Gypsy Moth program, which relies on aerial application of a gypsy moth mating disruption product, SPLAT GM-O, to limit the expansion of this pest's range across US northeast forests in 10 states.

Despite the advantages of semiochemical-based pest control tactics, products using these compounds have yet to gain traction in an important sector of agriculture: management of insect pests of row crops. The acreages devoted to the cultivation of these crops are far larger than those used for orchard or fruit crops, so the amount of semiochemical AIs that would need to be applied to cover this ground would be prohibitively large considering the high cost of these AIs ($1,000-3,500/kg). These feasibility concerns are exacerbated by the fact that multiple pest species often feed on the same crop. Most pheromone formulations developed to date have been species specific, so each pest in the field would require its own specific formulation to be applied.

Noctuid moths are a prime example of a pest group that has been considered unsuitable for semiochemical-based control methods, as they feed on a broad range of row crops and often have overlapping host and geographic ranges. While the use of semiochemicals for noctuid control has largely been limited to the use of pheromone-lured traps to monitor pest population density and aid in proper timing of control actions, pheromone-based control has been tested several times and has produced strong results against specific noctuids. Rate of mating among H. zea was cut in half in a 1982 study, during which a hollow fiber formulation containing a sex pheromone component of that species [(Z)-9-tetradecenyl formate] was applied over a 12-ha maize field. Beet armyworm also proved susceptible to mating disruption: Wakamura and Takai (1992) estimated that pheromone saturation of the crop field virtually eliminated mating, reducing it by 97%. Two sprayable A&K formulations have also been registered for Helicoverpa pests in Australia and South Africa. Unfortunately, these promising results have not translated into a large commercial market for pheromone-based products, presumably because of the limitation of species specificity. Furthermore, AIs of noctuid sex pheromones are considered too costly for use in row crops, where a pest control solution must cost the grower <$30/acre ($74/ha) to be considered economically viable.

An alternative group of semiochemicals are plant-produced kairomones, defined as semiochemicals produced by one species and responded to by another (whereas pheromones are produced and responded to by members of the same species). Kairomones play many roles in influencing insect behavior, including the selection of host plants among non-hosts, assessment of the quality or suitability of a plant for feeding or oviposition, and initiation or termination of aggregation behaviors. Kairomones are generally less selective in their activity than sex pheromones and can therefore be used to target a broader range of pest species and are effective against both sexes rather than against males only. In fact, some plant attractants have been shown to be more potent lures to gravid female moths than to males or virgin females, which could be expected to have an expanded impact on the pest population in the treated area.

This approach has been tested against several moth pest species. Plant compounds that have been shown to attract noctuids include methyl salicylate, phenylacetaldehyde, methyl-2-methoxy benzoate, 2-phenylethanol, linalool, and benzyl alcohol. A 2011 trapping study conducted in Hawaii assessed attraction of moths to a blend of floral-produced compounds placed in mixed fields of cabbage (Brassica oleracea), Chinese kale (B. kali), turnip mustard (B. alboglabra), squash (Cucurbita spp.), artichoke (Cynara scolymus), lettuce (Lactuca sativa), and radish (Raphanus sativa). Traps baited with these compounds captured both males and females of Chrysodeixis eriosoma, green garden looper; Autographa biloba, bi-lobed looper; and Mythimna unipuncta, true armyworm. These results suggested that the tested compounds might serve as attractants for monitoring lures or as a component in an A&K strategy but did not provide sufficient evidence of efficacy to justify their use in integrated pest management (IPM) programs. One of the floral volatiles assessed in the Hawaii trapping study, phenylacetaldehyde, also has been evaluated in an A&K strategy, in which this compound was deployed to lure cabbage looper moths to food baits laced with insecticide. A similar strategy also was tested with alfalfa looper using a pesticide-treated visual target, but both these researches were fairly preliminary and have yet to be developed into effective commercial products.

However, the use of semiochemicals (behavior-modifying chemicals) to achieve control of agricultural pests has been deemed too expensive an approach for large-scale row crops, due not only to the high cost of semiochemical active ingredients (AI) but also because of the labor costs of the manual application methods and devices that most of these techniques require.

As such, there is a need for alternative methods of controlling noctuid pests that is economically feasible and long lasting. In particular there is a need for an effective, field-hardy A&K formulation that can be deployed to protect a vast array of row and vegetable crops against damage by virtually any noctuid pest, and that will maintain its efficacy for a period of 3-4 weeks regardless of weather conditions.

### BRIEF SUMMARY

In accordance with one embodiment of the present disclosure, there is contemplated a method of controlling a noctuid population in a region. The method includes administering a composition having at least one attractant to a noctuid to the region. In some embodiments the attractant may be a semiochemical. In more particularity, the semiochemical may be a pheromone. In even more particularity, the semiochemical may be an oleoresin.

The composition may further include at least one feeding stimulant. In particular, the feeding stimulant may be a sugar.

The composition may also further include at least one pesticide. In certain embodiments, the pesticide may be present in the composition in a range of approximately 0.1% to approximately 2%. In particular, the pesticide may be present in the composition in an amount of about 2%. The pesticide may be methomyl, emamectin benzoate, spinetoram, or any suitable pesticide.

Notably, the composition may be rainfast and retain its efficacy for at least 24 hours. In certain embodiments, the composition may retain its efficacy for at least 3 weeks.

The composition may be administered to the region at a volume range of approximately 0.5 L/ha to approximately 1.0 L/ha. Additionally, the composition may be administered to the region in a skipped row pattern.

Another embodiment of the present disclosure contemplates a composition for controlling a noctuid population comprising at least one noctuid attractant. In particular, the attractant may be an oleoresin. Furthermore, the composition may also include at least one feeding stimulant and/or at least one pesticide.

### DETAILED DESCRIPTION

The detailed description set forth below is intended as a description of the presently preferred embodiment of the invention, and is not intended to represent the only form in which the present invention may be constructed or utilized. The description sets forth the functions and sequences of steps for constructing and operating the invention. It is to be understood, however, that the same or equivalent functions and sequences may be accomplished by different embodiments and that they are also intended to be encompassed within the scope of the invention.

One aspect of the present disclosure is a semiochemical-based, long-lasting A&K formulation for adult noctuids of multiple pest species. The formulations of the present disclosure are capable of large-scale application to multiple varieties of row crops susceptible to attack by noctuid pests. In particular, the semiochemical blend may contain floral attractants and feeding stimulants that draw noctuid moths across distances to the point sources and encourage them to contact and feed on the material, ensuring an intense exposure to the insecticidal agent also present in the formulation. This technology is amenable to the inclusion of a wide variety of control agents, safeguarding the efficacy of the formulation from the development of resistance to any one chemical and, at the same time, providing increased crop protection while drastically reducing the volume of insecticides needed to control the pests. These formulations may also be designed to remain affixed to its substrate regardless of adverse weather conditions and to maintain its efficacy for at least 3-4 weeks.

One aspect of the present disclosure is a novel tool for the control of noctuid moths: a semiochemical-based A&K product for noctuids of multiple pest species, including all those listed above. This formulation utilizes a potent blend of floral attractants and feeding stimulants designed to mimic the nectars from which these insects obtain nourishment as adults. Combined with an insecticide of choice and sprayed among the crops at low volume 0.5-1.0 L/ha), an application of this novel tool will use only 1-2% of the pesticide AI that would be required for a traditional cover spray. When applied in a skipped row pattern of application, the majority of the crop will remain pesticide-free, preserving beneficial insect populations. The incorporated attractants will draw noctuids to the formulation across distances (10s to 100s of m) to feed upon it to full engorgement, ensuring a megadose intake of the incorporated killing agent and making it highly unlikely that the pest population will have the opportunity to develop resistance to it.

The product's amenability to the inclusion of multiple pesticide classes serves as an additional safeguard against resistance, as it avoids becoming locked into dependency on any one chemical pesticide. This A&K product will target as broad a range of noctuid pests as Bt crops and other previously used pesticides, without the high costs of development of the former or the health and environmental hazards of the latter. The product will also be a far more economically viable solution than previous semiochemical-based strategies, most of which are species specific—therefore cost-prohibitive where multiple noctuid species are present—and require manual application. Unlike previous sprayable A&K products, this product will remain effective for 3-4 weeks regardless of weather conditions. This technology will revolutionize noctuid pest control, by demonstrating the efficacy and feasibility of semiochemical-based techniques for the protection of large acreage row crops, where they have long been considered too costly and cumbersome a strategy to be viable.

A liquid composition is disclosed which when mixed with certain insecticides induces insect, more specifically lepidoptera, to respond by attraction, manipulation and phagostimulation of the formulation which causes the insects to have reduced reproductive viability, including death. The composition retains its effect and activity after field application to susceptible founa under normal ambient conditions, maintaining attraction and insecticidal effect for a period of at least twenty-four hours by combining the adjuvant with a specific insecticide. The combination of the adjuvant and the insecticide composition upon application to the field, or vegetation, has the unexpected property of retaining its attraction, phagostimulation and toxic activity throughout the maximum residence time necessary for effective pest control by virtue of the fact that the composition resists being washed by humidity, protecting both insecticide and attractants and phagostimulants, while still allowing insects to feed on, and manipulate, the resulting treatment.

Initial work on products of the present disclosure consisted of a blend of oleoresins designed to mimic the attractive volatiles used by adult noctuids to identify sugar-rich sources of floral nectar. This blend also contains a number of sugar-based and proteic phagostimulants (feeding stimulants) to encourage the target insects to feed on the formulation to full engorgement. When a pesticide is added to this product, these components encourage megadose intake of the incorporated killing agent. This minimizes the risk of sub-lethal exposure, a contributing factor to the development of resistance. To further reduce the risk of resistance, the product may be designed as a tank mix to be blended with a small dose of the user's pesticide of choice just prior to application. This characteristic makes the product an extremely adaptable pest management solution and lends itself well to pesticide rotation programs. The product was originally tested in cotton and soybean fields in South America, where noctuid pests pose a significant economic threat to multiple crops. When blended with a 2% solution of the carbamate insecticide, methomyl, and applied to cotton crops in a skipped row pattern (applied over one 20-100 cm-wide strip, every 100 m), Noctovi succeeded in attracting and killing large numbers of four noctuid groups, Hehcoverpa, Heliothis, Plusias, and in lower numbers, Spodoptera spp.—significantly larger than in plots treated with a sugar solution of 2% methomyl. A later trial compared the same formulation, the product described herein with 2% methomyl, to a grower's standard application rate and method for methomyl alone, cover sprayed over the entire crop in Brazilian cotton fields, with similar results: In plots treated by the product of the present disclosure, an average of 16.2 dead moths/linear m, a mean total of 145.9 dead moths, were found per sampling site the day after the application, decreasing to 2.8 dead moths/linear m, a mean total of 25.25 dead moths, 5 days post-application. In contrast, no or very few dead moths were recovered from sites where methomyl was sprayed over the entire crop for 5 days after the application.

While this trial provided encouraging evidence of the product's efficacy, its persistence in the field was brief, lasting only about a week and less if exposed to heavy rain. A number of adjustments to the formulation to improve its persistence under rain, was made resulting in a rainfast prototype formulation. This prototype was tested against fall armyworm in combination with a mating disruption product for this species, SPLAT FAW, in a series of field trials in non-Bt corn and cotton crops in Brazil. The product of the present disclosure blended with 2% methomyl was applied alone or with varying application rates of SPLAT FAW (0.5, 1.0, or 1.5 kg/ha) to 50-ha plots treated with growers' standard pesticide regime. Treatment with the product of the present disclosure suppressed adult FAW populations in both field trials in corn, while in the cotton trial, male trap captures remained at or near zero for most of the trial. The results of infestation and damage assessments were less consistent, but in several cases, the product of the present disclosure suppressed crop damage, as well as increasing yield. In non-Bt maize, crop yield was increased by ˜250 kg/ha compared to plots treated with standard control alone in the Jiacara field trial, and by ˜2,200 kg/ha (with additional SPLAT FAW treatment) in Campo Verde. In the cotton trial, conducted in Campo Verde, despite cotton flowers suffering higher infestation rates across all treatments compared to the growers' standard, damage to green cotton bolls was reduced with the product of the present disclosure and SPLAT FAW treatments than in the control plots. Cotton yield was 17.4% and 4.9% higher in the two iterations of the Campo Verde trial. Despite these positive results, this formulation displayed some physical instability that interfered with the application process. A third prototype formulation was therefore developed, seeking to maintain greater persistence under rainfall but with a more consistent and stable formulation. This third prototype, was subjected to two simulated rain trials along with the original formulation and the second formulation. A series of 0.1-g point sources of each formulation were applied to glass slides and subjected to 20-mm increments of simulated rain (180 mm total). The third formulation outperformed both the first and second, maintaining an average persistence of 95-100% after exposure to 180 mm simulated rain when allowed to dry for 24 hr before the experiment, while the first and second formulation averaged <24% and <50%, respectively. When drying time was shortened to 4 hr, the third formulation persistence averaged 75-94%. This formulation was also more stable than the second, but still experienced some phase separation that had to be corrected by agitating the formulation.

Because the product disclosed herein contains attractants designed to mimic floral odors, preliminary semi-field studies were conducted in Brazil to identify any impacts of the formulation on bees. Ten colonies of Africanized honeybees were presented with two formulations with or without the addition of a proprietary bee repellent, in the presence or absence of honey, a potent natural attractant for the species, presented on foraging stations 30 m from the apiary (1.5 m apart) in a variety of configurations. The number of bees attracted to the formulations were observed and recorded every 10 minutes (290 min total). When the formulations were presented alone (in three 5-mL parallel strips) without honey in a no-choice test, three out of four formulations attracted 0 bees for the entire experiment, while the remaining formulation attracted only a single bee (average of 0.03/observation period). In contrast, a plate of pure honey, presented in the same way, attracted a total of 804 bees (27.72 bees/period). A larger quantity of the formulation presented, 100 mL, applied to boost any attractive effect, had no impact on these results: The highest average per observation period for any treatment was 0.25 bees per replicate, 0.45% of the average attracted to honey: 55.3 bees. Only 1 bee was found on the water control, an average of 0.01 bees per replicate.

In a third experiment, two plates were placed on each foraging station, balanced on opposite ends of a 90-cm wooden board, one designated as “Treatment” and the other as “Control.” The formulations of the present disclosure were applied in 5-mL strips on the Treatment plate, while 5-mL strips of honey were applied on the Control plate. When bees were presented with this choice between the formulation of the present disclosure and honey, they overwhelmingly chose the latter. The total number of bees found attempting to forage on the formulations of the present disclosure varied from 0 to 3 individuals (ave. 0-0.06/station), vs. 1604-1681 bees on honey (ave. 33.42-35.02/station). In the control treatment, consisting of two presentations of honey on opposite ends of the board, a roughly equal number of bees were attracted to each plate, 1681 vs. 1612 bees. Finally, two additional semi-field experiments assessed any potential repellency the formulations of the present disclosure might exert against bees. A treatment plate presenting honey surrounded by the test formulation of the present disclosure was placed at one end of a 90-cm board (Treatment), while a second plate containing honey surrounded by water (Control) was placed at the opposite end. Formulations and honey were applied in 5-mL strips (honey in the center, flanked by strips of formulation of the present disclosure on the Treatment plates and strips of water on the Control) in Experiment 4, and as small circular dollops (honey in the center, surrounded by a ring of 24 formulation droplets, or 24 water droplets in the Control) in Experiment 5. In both setups, the formulation of the present disclosure applied on the same surface as honey reduced bee foraging on the natural attractant. These collective results demonstrate that not only does the formulation of the present disclosure display little to no attraction to honeybees, there is some indication that this floral matrix is actually repellent to them.

One particularly promising alternative embodiment, which has proven an effective delivery mechanism for multiple classes of insect attractants, is the utilization of the biologically inert controlled-release matrix, SPLAT® (Specialized Pheromone and Lure Application Technology) described in U.S. Pat. No. 7,887,828, the entirety of which is incorporated by reference herein. This matrix is comprised entirely of food-safe, organic inert ingredients, adheres quickly and effectively to a wide variety of substrates including plant bark and foliage, and has demonstrated a consistent ability to release a broad range of attractants, repellents, phagostimulants, and other behavior modifying chemicals (also known as semiochemicals) at biologically active release rates, enabling season-long control for many insect pests.

This disclosure provides one of the first demonstrations of the feasibility of a semiochemical-based technology for pest control in row crops. By overcoming a long-held belief that these approaches are not viable for any but high-value crops, the success of this project gives these safe, sustainable technologies a new advantage in a sector of agriculture now dominated by conventional pesticides. Because the formulations of the present disclosure require only 1-2% of the pesticide used in cover sprays, its use among row crops will reduce crop contamination and risks to farm workers, consumers, and the environment. Finally, because it functions with different toxicants and includes a mechanism of megadose intake, it provides a helpful tool to combat resistance—a phenomenon that left unaddressed could pose a significant threat to long-term food and crop stability.

The formulations of the present disclosure may be applied at a rate of 0.5 L/ha, compared to 2.5 L/ha for ultralow volume pesticides, and up to 200 L/ha for conventional pesticides requiring water dilution. A large AirCat spray airplane with a holding tank of 2,000 L would be able to apply the formulations of the present disclosure to 4,000 ha in a single flight, compared to only 800 ha of ULV pesticide or 10 ha of conventional pesticide. Because the formulation of the present disclosure attracts the pest moths to a killing agent, it does not need to be applied over the entire treated area. If applied in a skipped row pattern, (one strip/100 linear m in every treated ha), an entire ha could be treated with a single pass. One pass by a large spraying tractor or airplane covers at most a width of 25 m (at least four passes of spray to cover 1 ha). This makes the application of the formulation described herein four times faster than a conventional spray at ¼th of the cost. When considering the efficiencies achieved due to extreme low volume, single pass application, the formulation of the present disclosure is 14 times less expensive to apply than even the most efficient ULV pesticides. When applying conventional pesticides, the goal is to maximize the amount of chemical that reaches the area to be treated and minimize the amount reaching other areas. However, to penetrate the crop canopy, an excess of pesticide is usually used, dispersed as a fine mist that is susceptible to spray drift (movement of pesticide dust or droplets through the air to sites beyond target area). Spray drift may harm human health, companion animals or livestock, the environment, nearby crops or land on other property. There is little to no drift with the formulation of the present disclosure, as it contains only 1-2% pesticide and is deposited on the surface of the crop as large dollops of 0.1-1 mL, unsusceptible to crosswind drift. The formulation of the present disclosure will therefore provide a method of control for noctuid row crop pests that is effective, practical, and sustainable.

The composition of the present disclosure is a chemical formulation of attractants and insecticide consisting of a potent blend of floral attractants and feeding stimulants along with a small quantity of a reduced-risk insecticide.

This composition is a novel alternative method of insect control. The novelty comes from the functional technical features of the composition and how they work together. The novel composition provides both an efficacious and environmentally friendly control technology for noctuid moth pests of agriculture. The composition is rainfast, retaining its effect and activity after application maintaining attraction and insecticidal effect for (at least 24 hours).

The composition is a field-worthy attract-and-kill (A&K) formulation that provides effective, long-lasting control of noctuid pests with added technical, economic, and social benefits. The claims and benefits include: increased efficacy in comparison to conventional insecticide application at labeled rate; increased mortality rate of the pest due to topical contact and ingestion by the pest; rain fastness—longevity of insecticidal activity in comparison to conventional insecticide application at labeled rate; reduced insecticide used, about 2% of conventional application at labeled rate; reduction of potential health effects due to reduction in insecticide; reduction of environmental toxicity due to reduction in insecticide; reduction in water used; reduction in application time and fuel/energy use; reduction in grower cost; reduction in beneficial and non-target insect impact; reduction in insect resistance potential (point source of lethal dose & ability to rotate with different insecticides with different modes of action); and reduction of insecticide drift potential (formulation holding reduced insecticide from rapid volatilization).

Because an application of this composition will require only a tiny fraction of the pesticide used in a conventional cover spray, this product will reduce reliance on these chemicals, which are associated with a broad range of health and environmental risks. Adoption of semiochemical products such as this composition will make pest control actions more sustainable, reducing spray drift and agricultural run-off. This composition will also decrease post-harvest processing costs of ensuring crops are within insecticide tolerance limits.

Row crops susceptible to attack by these pests include some of the most critical food staples within the US and around the globe, such as corn, wheat, and soybean. Noctuids have proven difficult to control using conventional pesticides because of their high reproductive and migratory capacity and their ability to develop resistance to insecticides.

The compositions of the present disclosure may comprise a blend of oleoresins and sugars which attract the moths and encourage them to feed, with an insecticide to serve as an attract and kill formulation. In particular, the pesticide may be present in the formulation in a range from approximately 0.1% to approximately 2%. While many pesticides may be used, depending on the preference, and even multiple pesticides at once, examples of pesticides that may be used with the present formulations include, but are not limited to, methomyl, emamectin benzoate, and spinetoram.

The above description is given by way of example, and not limitation. Given the above disclosure, one skilled in the art could devise variations that are within the scope and spirit of the invention disclosed herein, including various ways of dispersing the compositions. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A method of controlling a noctuid population in a region, the method comprising administering a composition comprising at least one attractant to a noctuid to the region.

2. The method of claim 1, wherein the attractant is a semiochemical.

3. The method of claim 2, wherein the semiochemical is a pheromone.

4. The method of claim 2, wherein the semiochemical is an oleoresin.

5. The method of claim 1, wherein the composition further comprises at least one feeding stimulant.

6. The method of claim 5, wherein the at least one feeding stimulant is a sugar.

7. The method of claim 1, further comprising at least one pesticide.

8. The method of claim 7, wherein the at least one pesticide is present in the composition in a range of approximately 0.1% to approximately 2%.

9. The method of claim 8, wherein the at least one pesticide is present in the composition in an amount of about 2%.

10. The method of claim 1, wherein the composition is rainfast and retains its efficacy for at least 24 hours.

11. The method of claim 1, wherein the composition retains its efficacy for at least 3 weeks.

12. The method of claim 1, wherein the composition is administered to the region at a volume range of approximately 0.5 L/ha to approximately 1.0 L/ha.

13. The method of claim 1, wherein the composition is administered to the region in a skipped row pattern.

14. The method of claim 7, wherein the at least one pesticide is methomyl.

15. The method of claim 7, wherein the at least one pesticide is emamectin benzoate.

16. The method of claim 7, wherein the at least one pesticide is spinetoram.

17. A composition for controlling a noctuid population comprising at least one noctuid attractant.

18. The composition of claim 17, wherein the at least one noctuid attractant is an oleoresin.

19. The composition of claim 17, further comprising at least one feeding stimulant.

20. The composition of claim 17, further comprising at least one pesticide.
